(19) United States
(12) Patent Application Publication
(10) Pub. No.: US 2012/0297955 A1
(43) Pub. Date: Nov. 29, 2012

(54) FINGER PUPPET GUITAR SLIDE

(76) Inventor: Jeffrey Shook, Canoga Park, CA (US)

(21) Appl. No.: 13/113,802

(22) Filed: May 23, 2011

(51) Int. Cl. G10D 3/00

(52) U.S. Cl. 84/319

(57) ABSTRACT

A finger puppet guitar slide and a finger puppet for a guitar slide are disclosed. In one embodiment, a finger puppet is sewn onto a cylindrical hollow metal piece comprising at least one hole on the surface of said metal piece through which a thread may enter. In a second embodiment, a finger puppet comprises an inner mould that allows the finger puppet to fit snugly only a typical guitar slide. In both embodiments, the finger puppet comprises a head portion and a body portion. The head portion covers the top of the guitar slide or cylindrical hollow metal piece, and the body portion covers some portion of the guitar slide or cylindrical hollow metal piece. The remaining uncovered portion of the guitar slide or cylindrical hollow metal piece can be placed upon strings of a musical instrument to vary vibrating length and pitch.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to the field of guitar slides. Guitar slides are known. Commonly, a guitar slide comprises a metal cylinder that fits around the finger and is placed upon guitar strings to vary their vibrating length and pitch.

More frequently, guitarists seek to utilize guitar slides that are more appealing than just a metal cylinder piece. For example, U.S. patent application Ser. No. 20090266220 published to Moncrief on Oct. 29, 2009 describes a musical instrument slide including a body portion and a light source. The light source includes a switch for selective activation, enabling the slide body to emit light when activated. As the guitarist moves the slide across the guitar strings, a visual effect is created by the movement of the light. The body portion preferably is constructed of a material to pass light there through, and can be either wholly or partially clear or translucent, or a combination of both. Alternatively, or in addition to the light source, the slide body can include an eccentric motor that causes the slide body to vibrate. This vibration, in turn, causes vibration of the guitar strings, or other string instrument, as the slide is positioned on the strings, or moved along the strings, by the guitarist.

Moreover, U.S. Pat. No. 7,572,964 issued to Sundby on Aug. 11, 2009 describes a ring-shaped guitar slide to accurately receive the guitarist's finger, upon which a second and wider half-cylindrical shaped bearing surface is attached via a tapered and joining rectangular base. The half-cylindrical bearing surface contacts with the guitar string(s) which vibrate against it. The device is constructed such that it also functions as jewelry, thereby being immediately accessible to the musician.

Finally, U.S. Pat. No. 5,450,778 issued to Roberts on Sep. 19, 1995 discloses a guitar slide which includes a generally tubular body having a conical outer surface tapering downward from a first open finger receiving end to a second smaller end. The outer surface and the inner surface are both preferably conical. The body is machined of an alloy. In another embodiment, the guitar slide is provided with a domed end.

Thus, the object of the present invention is to create a finger puppet guitar slide comprised of a cylindrical hollow metal piece and a finger puppet. In a preferred embodiment, the inside portion of the finger puppet is comprised of a mould that allows the finger puppet to snugly fit onto a typical guitar slide. A guitar slide can therefore have interchangeable finger puppets. In an alternate embodiment, the finger puppet is threaded onto a cylindrical hollow metal piece through at least one hole on the metal piece.

### SUMMARY

The invention comprises two embodiments: (1) a finger puppet guitar slide comprised of a cylindrical hollow metal piece and a finger puppet, and (2) a finger puppet for a guitar slide comprised of an inner mould. In the first embodiment, the finger puppet is threaded onto the cylindrical hollow metal piece through at least one hole on the metal piece. In the second, and preferred embodiment, the inside portion of the finger puppet is comprised of a mould that allows the finger puppet to snugly fit onto a typical guitar slide. In this embodiment, a guitar slide may have interchangeable finger puppets. The finger puppet itself comprises a head portion and a body portion.

### DRAWINGS

FIG. 1 shows a perspective view of the finger puppet guitar slide in actual use on the finger of a guitarist pressed against a guitar string(s).

FIG. 2 shows a perspective view of the finger puppet guitar slide featuring a furry animal attached to a cylindrical hollow metal piece.

FIG. 3 shows a back side view of one embodiment of the finger puppet guitar slide in which the finger puppet is threaded onto the guitar slide through two holes in cylindrical hollow metal piece.

FIG. 4. shows a bottom view of the finger puppet guitar slide.

FIG. 5 shows another embodiment of the invention showing a side view of an interchangeable finger puppet with an interior mould and a cylindrical hollow metal piece as separate pieces.

FIG. 6 shows a side view of the interchangeable finger puppet with interior mould joined with the cylindrical hollow metal piece.

FIG. 7 shows the interior mould of the finger puppet that fits onto a guitar slide.

FIG. 8 shows a bottom view of the finger puppet with interior mould.

### DETAILED DESCRIPTION

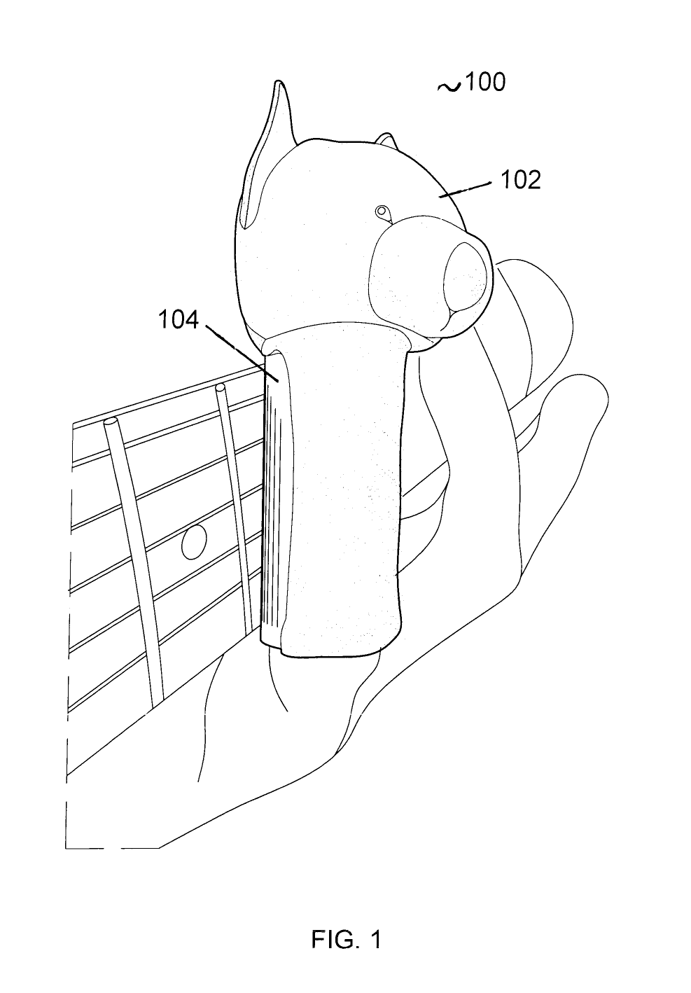

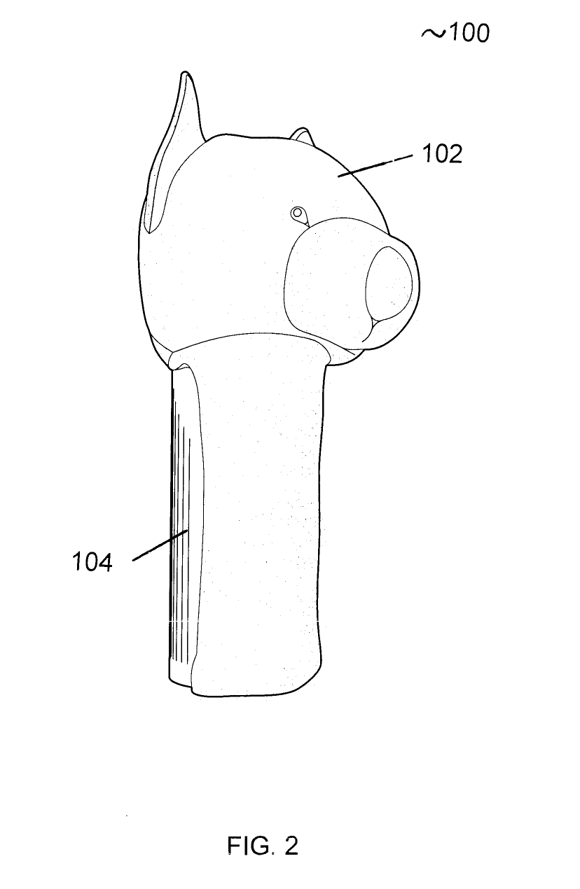

FIG. 1 shows the invention 100 in actual use on the finger of a user when playing a guitar. A cylindrical hollow metal piece 104 constitutes the guitar slide itself, which is partially covered by a finger puppet 102. As shown in FIG. 1, the finger puppet 102 covers only a portion of the cylindrical hollow metal piece 104 so that some portion of said metal piece is used as a guitar slide which can be placed against the strings of a guitar to vary the vibrating length and pitch. While it is understood that the invention 100 is intended for guitars, the invention 100 can also be used with other string instruments as the user desires. FIG. 2 shows a side view of the invention 100 comprised of a finger puppet 102 and cylindrical hollow metal piece 104.

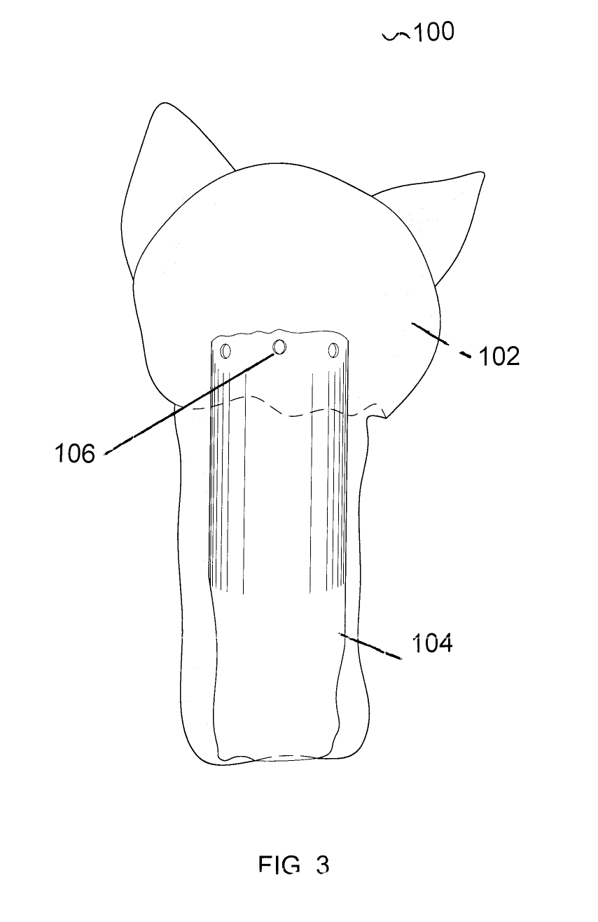

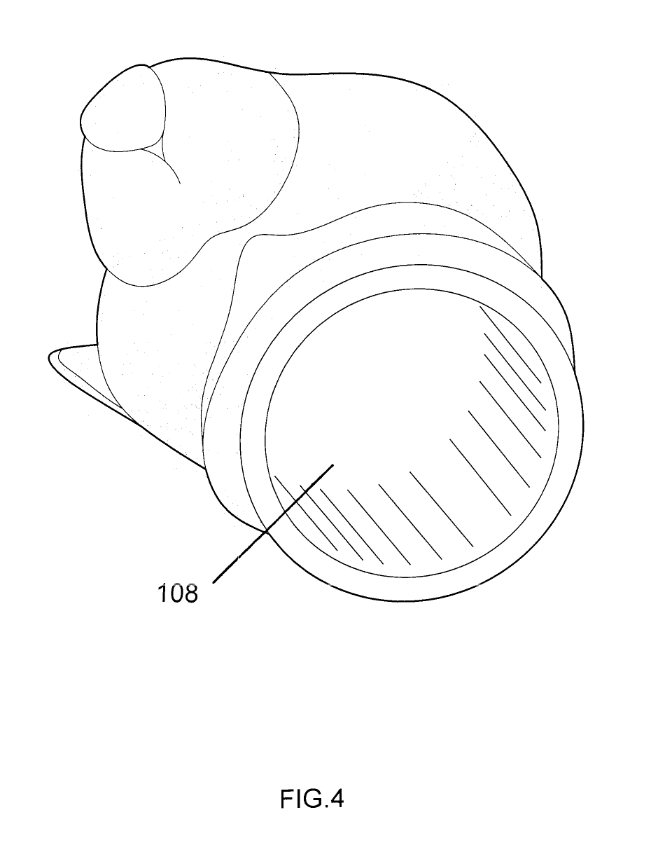

FIG. 3 shows one embodiment of the invention 100 wherein at least one hole 106 is used as the means for attaching the finger puppet 102 to the cylindrical hollow metal piece 104. A thread can be inserted through the at least one hole 106 and sewn onto the finger puppet 102. FIG. 4 shows a bottom view of this embodiment, wherein a finger insertion point 108 is visible.

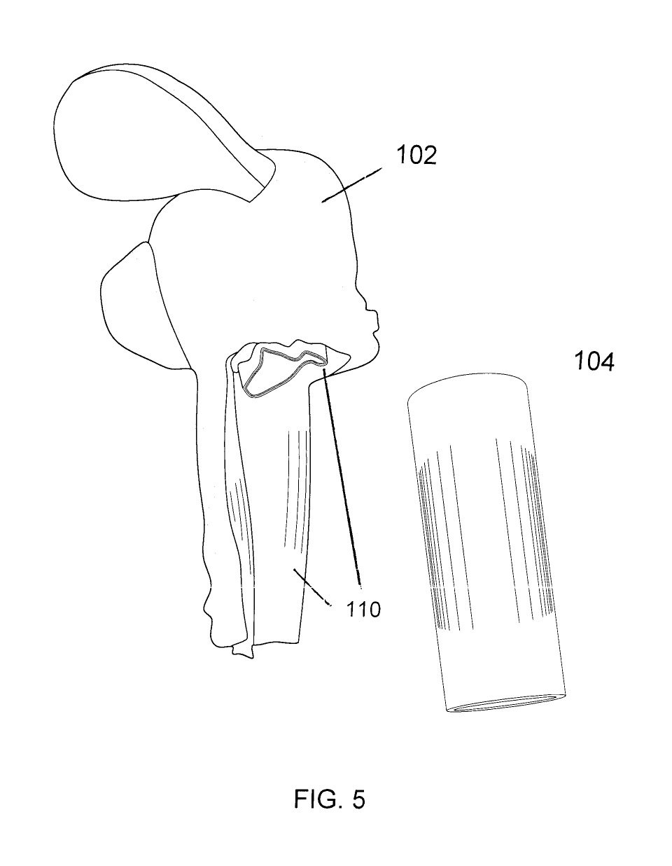

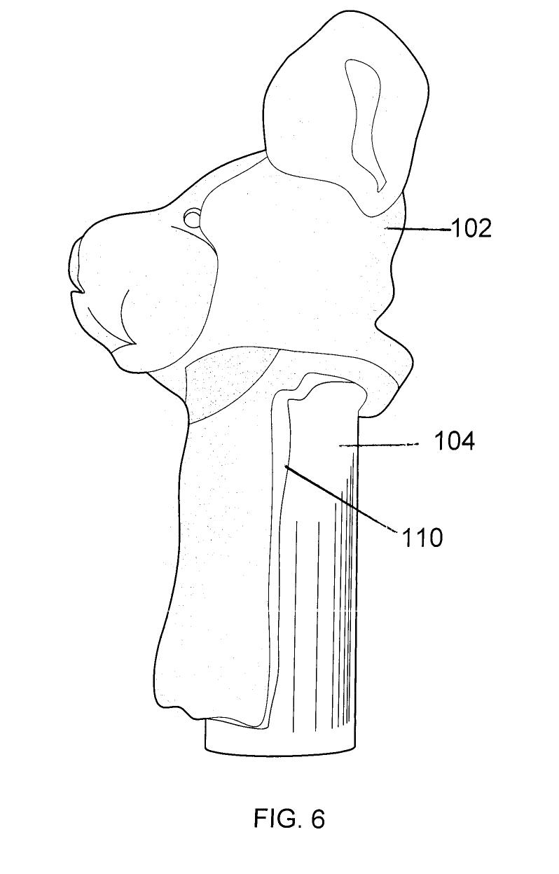

FIG. 5 shows the preferred embodiment of the invention 100. Here, the cylindrical hollow metal piece 104 is a typical guitar slide and the finger puppet 102 comprises an inner moulding 110 for a typical guitar slide. The inner moulding 110 allows the finger puppet 102 to fit snugly onto a typical guitar slide by adding friction to the inner surface of the finger puppet 102. In this embodiment, some portion of the inner moulding may also be inserted inside the top portion of a guitar slide. FIG. 6 is a side view of this embodiment wherein a portion of the inner moulding 110 is visible when the finger puppet 102 is placed on a guitar slide.

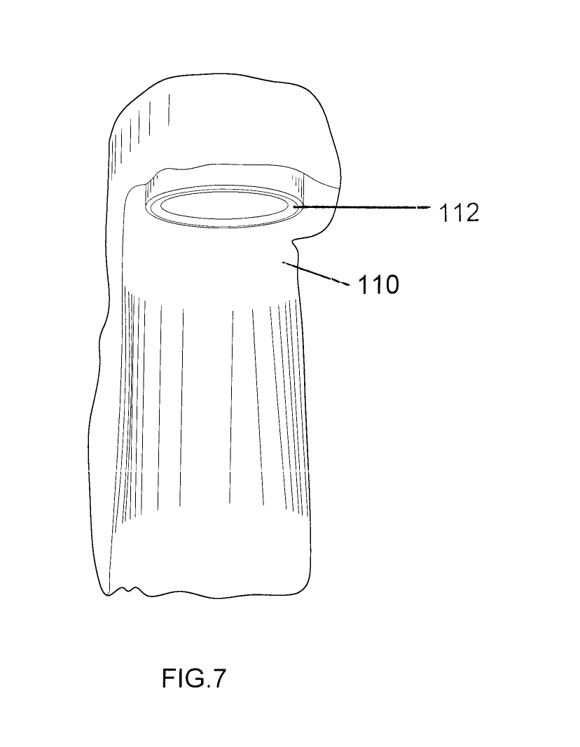

FIG. 7 shows the inner moulding 110 itself apart from the finger puppet 102. Contrary to FIG. 5 where the portion of the inner moulding 110 that inserts into the top portion of the guitar slide is jagged, FIG. 7 shows the same portion of the inner moulding 110 as smooth. As long as the inner moulding 110 extends into the top inner portion of a guitar slide, as well as against some portion of the body of a guitar slide, the inner moulding 110 will prevent the finger puppet 102 from shifting while the guitar slide is in use.

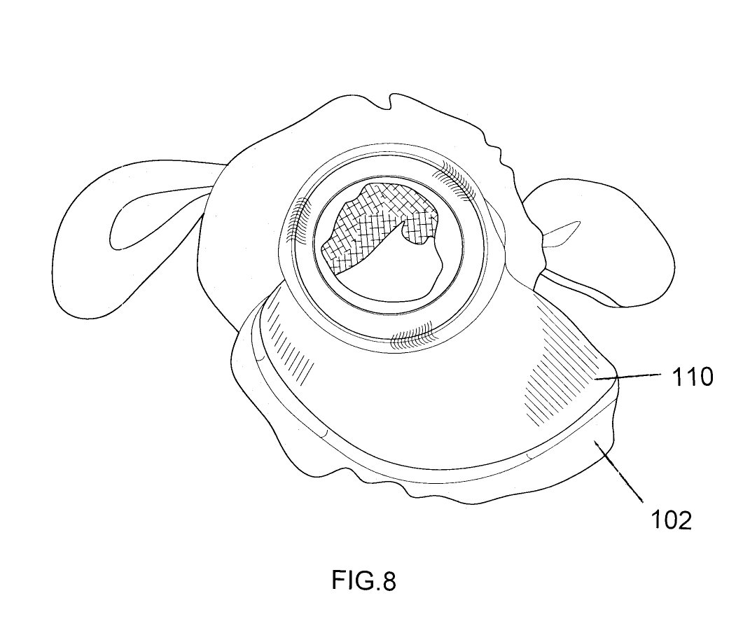

FIG. 8 shows a bottom view of the finger puppet 102 with inner moulding 110.

It is to be understood that a finger puppet is not limited to only an animal figure as depicted in the drawings, but can also be a person, fanciful or fictional beings, inanimate objects, body parts, etc.

I claim the following:

1. A finger puppet guitar slide comprised of a cylindrical hollow metal piece and a finger puppet,
wherein the cylindrical hollow metal piece has an opening at the bottom for insertion of a finger, and
wherein the finger puppet covers the top portion of the cylindrical hollow metal piece and at least some portion of the body of the cylindrical hollow metal piece, while the remaining portions of the cylindrical hollow metal piece remains uncovered and can be used for placement on strings of a musical instrument to vary the vibrating length and pitch of the musical instrument.

2. The finger puppet guitar slide of claim 1, wherein the musical instrument is a guitar.

3. The finger puppet guitar slide of claim 1, wherein the cylindrical hollow metal piece comprises at least one hole on the surface of the cylindrical hollow metal piece, through which a thread can be inserted.

4. The finger puppet guitar slide of claim 1, wherein the finger puppet is an animal figure, a person, a fanciful or fictional being, an inanimate object, or a body part.

5. A finger puppet for a guitar slide comprised of a head portion and a body portion, wherein the inner surface of the head portion and body portion comprise a moulding for a guitar slide.

6. The finger puppet of claim 5, wherein a portion of the moulding extends into the top inner surface of a guitar slide.
